(19) United States
(12) Patent Application Publication
(10) Pub. No.: US 2020/0286510 A1
(43) Pub. Date: Sep. 10, 2020

(54) HARD DISK COMB, ACTUATOR, AND MANUFACTURING METHOD OF HARD DISK COMB

(71) Applicant: Fujikura Ltd., Tokyo (JP)

(72) Inventors: Ryo Yamaguchi, Sakura-shi (JP); Toshitaka Namba, Sakura-shi (JP); Daisuke Oku, Sakura-shi (JP); Kenji Takahashi, Sakura-shi (JP)

(73) Assignee: Fujikura Ltd., Tokyo (JP)

(21) Appl. No.: 16/806,042

(22) Filed: Mar. 2, 2020

(30) Foreign Application Priority Data
Mar. 4, 2019 (JP) 2019-038457

(51) Int. Cl. G11B 5/48; G11B 25/04

(52) U.S. Cl. CPC G11B 5/4813; G11B 5/488; G11B 25/043

(57) ABSTRACT

A hard disk comb includes: a main body including a groove; and an arm joined to the main body. A part of the arm is disposed inside the groove, and an opening edge of the groove is joined to an upper surface of the arm.

### CROSS-REFERENCE TO RELATED APPLICATIONS

This application claims priority to Japanese Patent Application No. 2019-038457 filed Mar. 4, 2019, the contents of which are incorporated herein by reference in their entirety.

### TECHNICAL FIELD

The present invention relates to a hard disk comb, an actuator, and a manufacturing method of the hard disk comb.

### BACKGROUND

A hard disk drive (HDD) is known as a large-capacity magnetic recording medium, and is widely used by being mounted on a personal computer (PC) or the like. Generally, the hard disk drive includes a rotating magnetic disk and an actuator having an arm to which a magnetic head is attached. Since the position of the magnetic head relative to the magnetic disk changes as the arm swings, information can be read or written at a predetermined position on the magnetic disk. Japanese Unexamined Patent Application first Publication No. 2002-197821 discloses an example of such an actuator.

In addition, a comb may be used as a component of the actuator. The comb is a component to which a plurality of arms are fixed at predetermined intervals.

In the related art, as a hard disk comb, an arm has been formed by cutting. However, in recent years, it is required to make the arm thinner for the purpose of increasing the capacity of the HDD, and the arm may not be formed by cutting because a thickness is too thin, or even when the arm could be formed, dimensional accuracy may not be ensured.

### SUMMARY

One or more embodiments of the present invention provide a hard disk comb capable of ensuring dimensional accuracy of an arm even in a case where a thickness of the arm is thin.

A hard disk comb according to one or more embodiments of the present invention includes a main body having a groove formed therein, and an arm joined to the main body, and a part of the arm is located inside the groove, and an opening edge of the groove and an upper surface of the arm are joined to each other.

According to one or more embodiments, the hard disk comb can be formed by forming the arm in advance by press working, for example, and fixing the arm to the main body. Therefore, dimensional accuracy of the arm can be ensured even when the thickness of the arm is thin, as compared with a case where the arm and the main body are integrally formed by cutting, for example.

Here, the arm may be formed in a plate shape having the upper surface and a lower surface, and among the upper surface and the lower surface, the only upper surface may be joined to the main body.

In addition, the arm and the main body may be joined to each other by welding, or may be joined by laser welding.

In these cases, each of the arms can be reliably joined to the main body even in a case where the gap between the arms is significantly small, by joining each of the arms in order from above or below.

In addition, at least three joining portions between the main body and the arm may be formed, and the three joining portions may not be disposed on a straight line.

In this case, since the joining portions are not disposed on a straight line, warpage of the arm due to the joining can be suppressed.

In addition, the arm may include an aluminum layer and SUS (Japanese Industrial Standards designation for stainless steel) layers provided on both surfaces of the aluminum layer, and the main body may be formed of SUS.

In this case, the arm and the main body can be welded by the SUS layer, and the aluminum layer is included, so that the weight of the arm can be reduced.

In addition, a gap may be provided between the arm and an inner surface of the groove.

In this case, the surface area of the main body increases and the volume of the main body decreases, as compared with the case where no gap is provided. As described above, the heat dissipation of the comb can be improved by increasing the surface area of the main body. In addition, the weight of the main body can be reduced by reducing the volume of the main body.

In addition, a part of the inner surface of the groove may be an inclined surface. And the inclined surface may face the arm with a gap interposed therebetween, the gap provided between the arm and the inner surface of the groove.

In this case, when the joining jig is inserted into the groove together with the arm during the manufacture of the hard disk comb, the inclined surface serves as a guide, and the manufacturing step can be further facilitated.

An actuator according to one or more embodiments of the present invention includes the hard disk comb, a suspension attached to a tip end portion of the arm, a magnetic head attached to the suspension, and a coil holding portion fixed to the main body, or integrally formed with the main body, and a coil held by the coil holding portion.

According to the actuator of one or more embodiments, the dimensional accuracy of the arm can be ensured even when the thickness of the arm is thin as described above, so that more arms and magnetic heads can be disposed in a small space. Therefore, it is possible to contribute to miniaturization and increase in capacity of the HDD.

A hard disk comb according to one or more embodiments of the present invention includes a main body having a groove formed therein; and an arm joined to the main body, wherein a part of the arm is located inside the groove, the arm has an aluminum layer and SUS layers provided on both surfaces of the aluminum layer, and the main body is formed of SUS.

According to one or more embodiments, the hard disk comb can be formed by forming the arm in advance by press working, for example, and fixing the arm to the main body. Therefore, dimensional accuracy of the arm can be ensured even when the thickness of the arm is thin, as compared with a case where the arm and the main body are integrally formed by cutting, for example. In addition, the arm and the main body can be welded by the SUS layer, and the aluminum layer is included, so that the weight of the arm can be reduced.

A manufacturing method of a hard disk comb according to one or more embodiments of the present invention includes preparing a main body having a groove formed therein, inserting an arm and a joining jig inside the groove, joining the arm and the main body, and extracting the joining jig from the groove.

By adopting such a manufacturing method, it is possible to fix the arm to the main body in a state where the surface of the arm is in close contact with the inner surface of the groove, while providing the gap between the inner surface of the groove and the arm. Therefore, the posture of the arm can be stabilized.

According to one or more embodiments of the present invention, it is possible to provide the hard disk comb capable of ensuring the dimensional accuracy of the arm even in a case where the thickness of the arm is thin.

### BRIEF DESCRIPTION OF THE DRAWINGS

FIG. 1 is a plan view of an actuator having a hard disk comb according to one or more embodiments.

FIG. 2 is a perspective view of the hard disk comb in FIG. 1.

FIG. 3 is a sectional view taken along a line III-III in FIG. 2.

FIG. 4A is a view showing a manufacturing method of the hard disk comb according to one or more embodiments.

FIG. 4B is a view showing a step following a step of FIG. 4A.

FIG. 4C is a view showing a step following the step of FIG. 4B.

FIG. 5 is a plan view of the hard disk comb according to one or more embodiments, and shows a position of a joining portion between an arm and a main body.

FIG. 6 is a sectional view of a hard disk comb according to one or more embodiments.

FIG. 7A is a view showing a manufacturing method of the hard disk comb according to one or more embodiments.

FIG. 7B is a view showing a step following a step of FIG. 7A.

FIG. 7C is a view showing a step following the step of FIG. 7B.

FIG. 8A is a sectional view of a hard disk comb according to one or more embodiments.

FIG. 8B is a view showing a manufacturing method of the hard disk comb according to one or more embodiments.

FIG. 9A is a sectional view of a hard disk comb according to one or more embodiments.

FIG. 9B is a view showing a manufacturing method of the hard disk comb of FIG. 9A.

### DETAILED DESCRIPTION

Hereinafter, a hard disk comb (hereinafter, referred to as a “comb”) and an actuator including a comb according to one or more embodiments will be described with reference to the drawings.

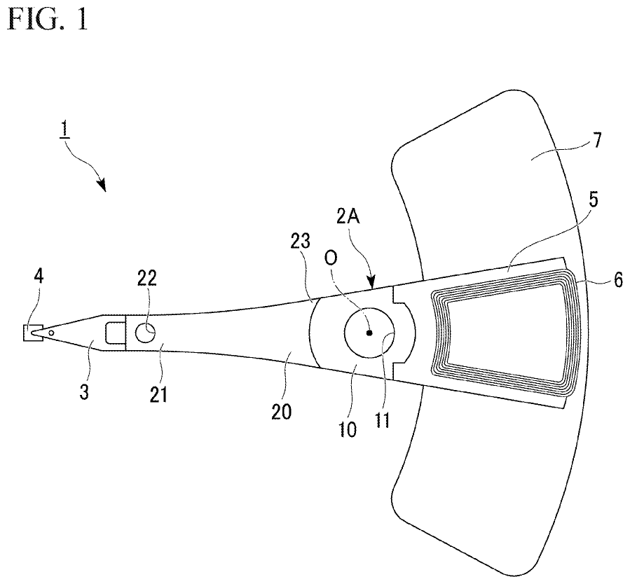

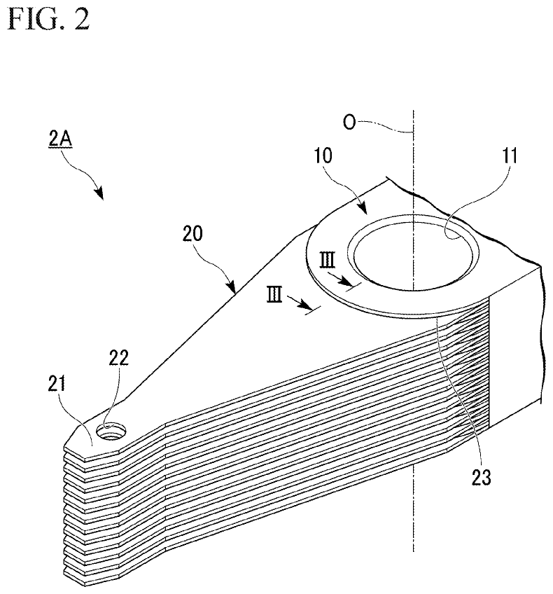

As shown in FIG. 1, an actuator 1 according to one or more embodiments includes a comb 2A, a suspension 3, a magnetic head 4, a coil holding portion 5, and a coil 6. The comb 2A includes a main body 10 and a plurality of arms 20 (refer to FIG. 2). An attachment hole 22 is formed in a tip end portion 21 of the arm 20. The suspension 3 is attached to the attachment hole 22 of the arm 20, and the magnetic head 4 is attached to the tip end portion of the suspension 3. That is, the magnetic head 4 is fixed to the arm 20 via the suspension 3.

The suspension 3 is formed of a plate material thinner than the arm 20. The magnetic head 4 is an electronic component in which a recording head and a reproducing head are integrated. Although not shown, the suspensions 3 and the magnetic heads 4 are attached to the plurality of arms 20, respectively. A plurality of magnetic heads 4 are in a state of floating with a small gap between a plurality of magnetic disks (not shown) inside the hard disk.

A pivot hole 11 is formed in the main body 10 of the comb 2A, and the comb 2A can swing around the pivot hole 11. In one or more embodiments, a direction where a central axis O of the pivot hole 11 extends is referred to as a vertical direction.

The coil holding portion 5 is fixed to the main body 10 of the comb 2A. A shape of the main body 10 can be appropriately changed, and for example, the coil holding portion 5 may be formed integrally with the main body 10.

The coil 6 is an air-core coil in which a conductive wire material such as copper is aligned and wound. The coil 6 is hardened by a resin (not shown) so that an aligned and wound state is maintained. The coil 6 is held by the coil holding portion 5. A pair of magnets 7 are disposed in the vicinity of the coil 6. The coil 6 is interposed between the pair of magnets 7. FIG. 1 shows only one of the pair of magnets 7 for easy understanding.

The actuator 1 is configured such that when a current flows through the coil 6, the main body 10 swings around the pivot hole 11. When the main body 10 swings, a position of the magnetic head 4 with respect to the magnetic disk changes, so that information can be read or written at a predetermined position on the magnetic disk.

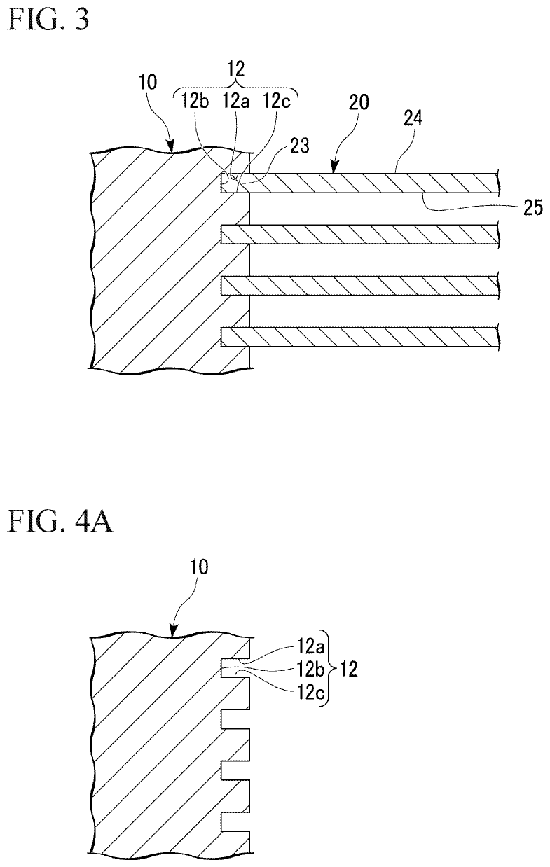

As shown in FIG. 2, the comb 2A according to one or more embodiments includes one main body 10 and the plurality of arms 20. Each of the arms 20 are formed in a plate shape having an upper surface 24 facing upward and a lower surface 25 facing downward (refer to FIG. 3). Each of the arms 20 are fixed to the main body 10 and are disposed at intervals in the vertical direction.

As a material of the main body 10, a metal such as SUS can be used. As a material of the arm 20, one type of metal such as SUS or a multilayer material in which a plurality of types of metals are laminated can be used. As the multilayer material, for example, a structure in which a SUS layer is formed on both surfaces of an aluminum layer can be adopted. In a case where the multilayer material is used as the arm 20, the upper surface 24 and the lower surface 25 of the arm 20 are formed of the SUS layer.

In the case where the multilayer material is used as the arm 20, the material of each layer may be appropriately changed. In this case, the upper surface 24 and the lower surface 25 of the arm 20 are formed of a first material suitable for joining with the main body 10 and a second material having a lower density than that of the first material may be provided between two layers of the first material.

As shown in FIG. 3, a plurality of grooves 12 are formed in the main body 10 according to one or more embodiments. The plurality of grooves 12 are formed at intervals in the vertical direction. A base end portion 23 of the arm 20 is located inside the groove 12. More specifically, the base end portion 23 is in contact with an upper inner surface 12a, a bottom surface 12b, and a lower inner surface 12c of the groove 12. The base end portion 23 of the arm 20 is an end portion of the two end portions in a longitudinal direction of the arm 20 where the magnetic head 4 is not provided. Although not shown, the bottom surface 12b of the groove 12 is formed in an arc shape when viewed from the vertical direction. In addition, a surface of the base end portion 23 of the arm 20 that is in contact with the bottom surface 12b is also formed in the same arc shape as the bottom surface 12b.

In one or more embodiments, the arm 20 is joined to the main body 10 in a state where the base end portion 23 of the arm 20 is inserted inside the groove 12. Here, “joining” in this specification includes welding, deposition, and adhesion. As the welding, for example, laser welding can be adopted. As the deposition, for example, brazing can be adopted. The materials of the main body 10 and the arm 20 may be appropriately selected according to the type of joining. For example, in a case where laser welding is adopted, the material of the main body 10 and the material of the surface of the arm 20 may be of the same type.

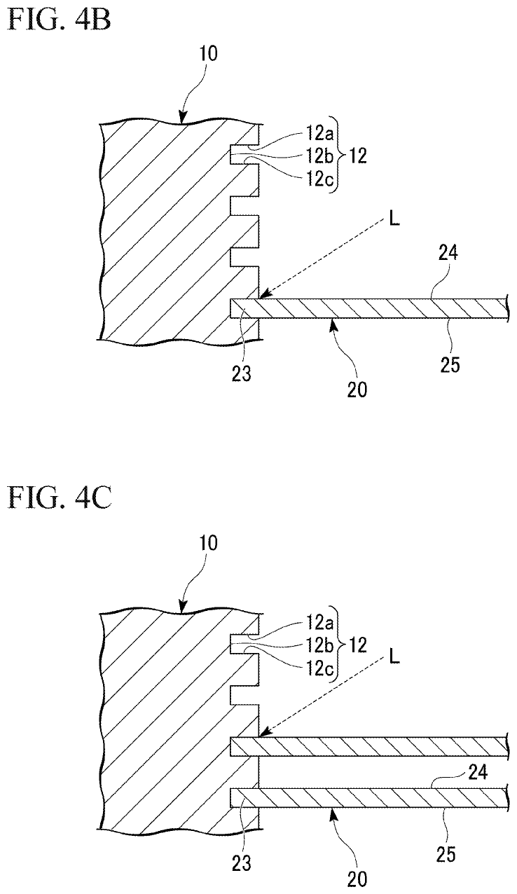

Next, a manufacturing method of the comb 2A according to one or more embodiments will be described with reference to FIGS. 4A to 4C.

First, as shown in FIG. 4A, the main body 10 having a plurality of grooves 12 formed therein is prepared. A forming method of the main body 10 can be appropriately selected, and for example, casting or cutting can be adopted.

Next, as shown in FIG. 4B, the base end portion 23 of the arm 20 is inserted into the groove 12 located at the lowest position. The arm 20 and the main body 10 are joined to each other. An example of FIG. 4B shows a case where laser welding using laser beam L is adopted as the joining method.

In FIG. 4B, the laser beam L is obliquely irradiated to the upper surface 24 of the arm 20.

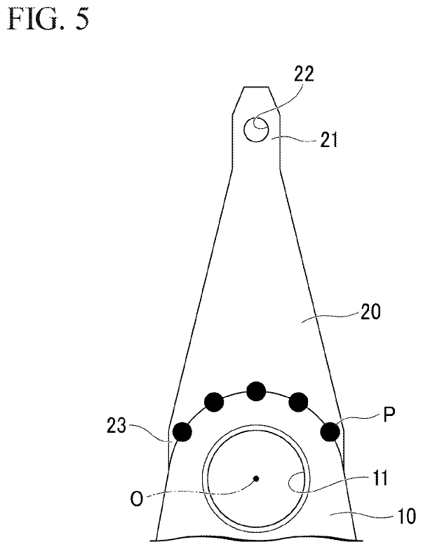

In addition, an irradiation position of the laser beam L is in the vicinity of an opening edge of the groove 12. In FIG. 4B, since the upper inner surface 12a of the groove 12 and an outer surface of the main body 10 are substantially perpendicular to each other, the irradiation position of the laser beam L is likely to be specified. By being irradiated with the laser beam L, the opening edge of the groove 12 and the upper surface 24 of the arm 20 are welded to each other. Although not shown in FIG. 4B, the laser beam L is irradiated a plurality of times along the opening edge of the groove 12 at intervals. As a result, a plurality of joining portions P are provided for one arm 20 (refer to FIG. 5).

As a result, the upper surface 24 of the arm 20 is joined to the main body 10, and the arm 20 is fixed to the main body 10.

Next, as shown in FIG. 4C, the base end portion 23 of the other arm 20 is inserted into the adjacent groove 12, and the other arm 20 and the main body 10 are joined to each other. By repeating this step, the comb 2A is obtained.

In FIGS. 4A to 4C, although the upper surface 24 of the arm 20 is joined to the main body 10, the lower surface 25 of the arm 20 may be joined to the main body 10. In this case, the base end portion 23 of the arm 20 is first inserted into the groove 12 located at the uppermost position, and the lower surface 25 of the arm 20 and the main body 10 are welded to each other. By sequentially joining the arms 20 to the adjacent grooves 12, the comb 2A is obtained.

Furthermore, among the upper surface 24 and the lower surface 25, the only upper surface 24 may be jointed to the main body 10.

As described above, the comb 2A according to one or more embodiments includes the main body 10 having the groove 12 formed therein and the arm 20 joined to the main body 10, and a part of the arm 20 is located inside the groove 12, and the opening edge of the groove 12 and the upper surface 24 of the arm 20 are joined to each other. As a result, the comb 2A can be formed by forming the arm 20 in advance by press working, for example, and fixing the arm 20 to the main body 10. Therefore, dimensional accuracy of the arm 20 can be ensured even when the thickness of the arm 20 is thin, as compared with a case where the arm 20 and the main body 10 are integrally formed by cutting, for example.

In addition, the arm 20 may be formed in a plate shape having an upper surface 24 and a lower surface 25, and among the upper surface 24 and the lower surface 25, the only upper surface 24 may be jointed to the main body 10. In this case, the joining portion P is easily visible, and it can be easily confirmed that the arm 20 and the main body 10 are joined to each other.

In FIGS. 4A to 4C, the laser beam L is used. For example, after applying an adhesive to the inside of the groove 12 or the base end portion 23 of the arm 20, the base end portion 23 is inserted into the groove 12. Therefore, the arm 20 and the main body 10 may be joined by adhesion. Alternatively, both the upper surface 24 and the lower surface 25 of the arm 20 may be joined to the main body 10 by the laser beam L. However, in a case where the interval between the arms 20 is significantly small, one of the upper surface 24 and the lower surface 25 of the arm 20 may be joined to the main body 10 and the other is not joined to the main body 10. The reason is that each of the arms 20 can be reliably joined to the main body 10 by joining each of the arms 20 in order from above or below, even in the case where the interval between the arms 20 is significantly small, as shown in FIGS. 4A to 4C.

In addition, the number and shape of the joining portions P provided for one arm 20 can be changed as appropriate.

Here, in a case where welding is used as joining method, the joining portion P is cooled after being heated, and a residual stress is generated in the vicinity of the joining portion P, so that the arm 20 after joining may be warped. Such a warpage is likely to occur in a case where the linear joining portions P are formed on a straight line. The linear joining portions P may be joining portions that extend along the opening edge of the groove 12 and the upper surface 24 of the arm 20. Therefore, for example, a plurality of dotted or linear joining portions P for one arm 20 may be disposed at intervals on a straight line. Alternatively, the linear joining portions P for one arm 20 may be formed so as to extend in a semicircular shape, for example, so that the linear joining portions P are not formed on a straight line. At least three joining portions P may be formed for one arm 20, and the three joining portions P may not be disposed on a straight line.

The points P shown in FIG. 5 indicate the position of the joining portions between the arm 20 and the main body 10 in one or more embodiments. As shown in FIG. 5, a plurality of joining portions P between the arm 20 and the main body 10 are provided according to one or more embodiments. Each joining portion P is dotted, not linear. In addition, the plurality of joining portions P are provided at intervals from each other, and are not disposed on a straight line.

As described above, the plurality of joining portions P are provided at intervals from each other and not disposed on a straight line, so that it is possible to more reliably suppress warpage of the arm 20 due to joining.

In addition, the arm 20 includes an aluminum layer and SUS layers provided on both surfaces of the aluminum layer, and the main body 10 may be formed of SUS. In this case, the arm 20 and the main body 10 can be welded by the SUS layer, and the weight of the arm 20 can be reduced by including the aluminum layer.

In addition, according to the actuator 1 of one or more embodiments, as described above, the dimensional accuracy of the arm 20 can be ensured even when the thickness of the arm 20 is thin, so that more arms 20 and the magnetic heads 4 can be disposed in a small space. Therefore, it is possible to contribute to miniaturization and increase in capacity of the HDD.

Next, one or more embodiments according to the present invention will be described, and the basic configuration is the same as that of the above-described embodiments. Therefore, the same components are denoted by the same reference numerals, a description thereof will be omitted, and only different points will be described.

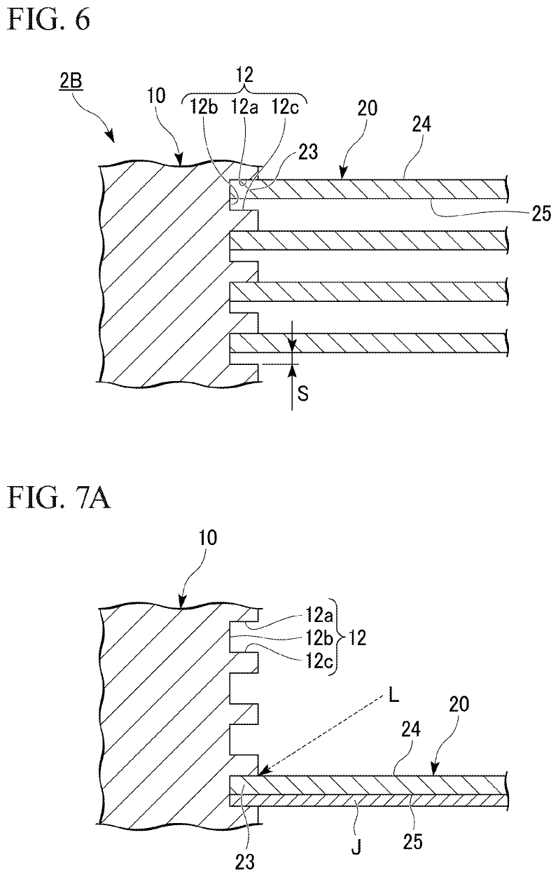

FIG. 6 is a sectional view of the comb 2B according to one or more embodiments. The position of the cross section corresponds to line III-III in FIG. 2. As shown in FIG. 6, according to one or more embodiments, a gap S is provided between the arm 20 and the inner surface of the groove 12.

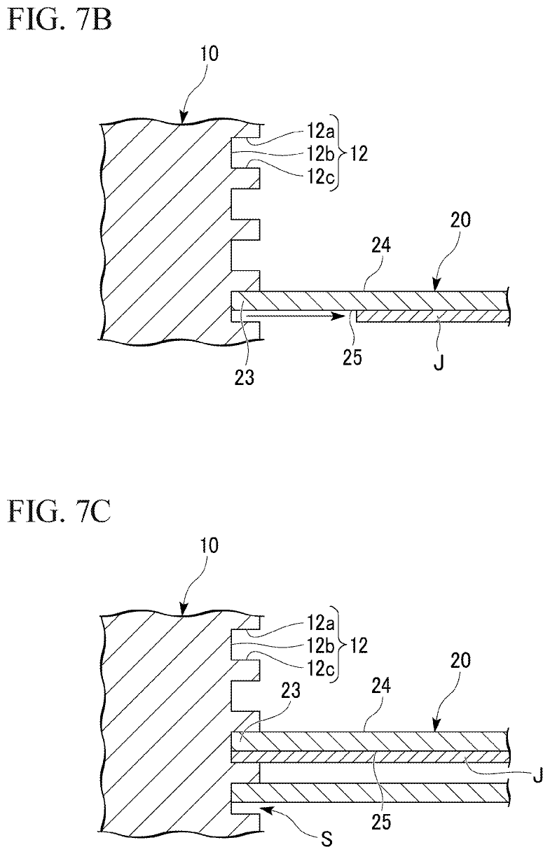

Next, a manufacturing method of the comb 2B according to one or more embodiments will be described with reference to FIGS. 7A to 7C.

First, as shown in FIG. 7A, the arm 20 and a joining jig J are inserted inside the groove 12 of the main body 10. At this time, the lower surface 25 of the arm 20 is in contact with the joining jig J. The portion of the joining jig J inserted inside the groove 12 has practically the same thickness as that of the gap S. Therefore, when the arm 20 and the joining jig J are inserted into the groove 12, the upper surface 24 of the base end portion 23 of the arm 20 comes into surface contact with the upper inner surface 12a of the groove 12. As a result, a posture of the arm 20 is set along the inner surface 12a of the groove 12. In addition, the position of the arm 20 in the longitudinal direction is also determined by the base end portion 23 abutting against the bottom surface 12b of the groove 12. By irradiating with the laser beam L in this state, the upper surface 24 of the arm 20 is joined to the main body 10, and the arm 20 is fixed to the main body 10.

The laser beam L is irradiated in the same manner as in the above-described embodiments. That is, the laser beam L is irradiated obliquely to the upper surface 24 of the arm 20, and the irradiation position of the laser beam L is in the vicinity of the opening edge of the groove 12. In FIG. 7A, since the upper inner surface 12a of the groove 12 and the outer surface of the main body 10 are substantially perpendicular to each other, the irradiation position of the laser beam L is likely to be specified. The laser beam L is irradiated a plurality of times along the opening edge of the groove 12 at intervals, and the plurality of joining portions P are provided for one arm 20 (refer to FIG. 5).

Next, as shown in FIG. 7B, the joining jig J is extracted from the groove 12. As a result, a gap S shown in FIG. 6 is formed.

Next, as shown in FIG. 7C, the arm 20 and the joining jig J are inserted into the adjacent grooves 12, and the arm 20 and the main body 10 are joined to each other.

By repeating such steps, the comb 2B according to one or more embodiments can be obtained.

In FIGS. 7A to 7C, the upper surface 24 of the arm 20 is joined to the main body 10, and the lower surface 25 of the arm 20 may be joined to the main body 10. In this case, first, the base end portion 23 of the arm 20 and the joining jig J are inserted into the uppermost groove 12 in a state where the upper surface 24 of the arm 20 is in contact with the joining jig J. At this time, the lower surface 25 of the arm 20 comes into surface contact with the lower inner surface 12c of the groove 12, and the base end portion 23 abuts against the bottom surface 12b of the groove 12. Next, the lower surface 25 of the arm 20 and the main body 10 are welded to each other, and the joining jig J is extracted.

Similarly, the comb 2B is obtained by sequentially joining the arms 20 to the adjacent grooves 12.

As described above, in the comb 2B according to one or more embodiments, the gap S is provided between the arm 20 and the inner surface of the groove 12. As a result, the surface area of the main body 10 increases and the volume of the main body 10 decreases, as compared with the case where the gap S is not provided. As described above, the heat dissipation of the comb 2B can be improved by increasing the surface area of the main body 10. In addition, the weight of the main body 10 can be reduced by reducing the volume of the main body 10.

In addition, in the manufacturing method of the comb 2B according to one or more embodiments, the main body 10 having the groove 12 formed therein is prepared, the arm 20 and the joining jig J are inserted inside the groove 12, the arm 20 and the main body 10 are joined to each other, and the joining jig J is extracted from the groove 12. By adopting such a manufacturing method, it is possible to fix the arm 20 to the main body 10 in a state where the surface of the arm 20 is in close contact with the inner surface of the groove 12 while providing the gap S as described above. Therefore, the posture of the arm 20 can be stabilized.

Next, one or more embodiments of the present invention will be described, and the basic configuration is the same as that of the above-described embodiments. Therefore, the same components are denoted by the same reference numerals, a description thereof will be omitted, and only different points will be described.

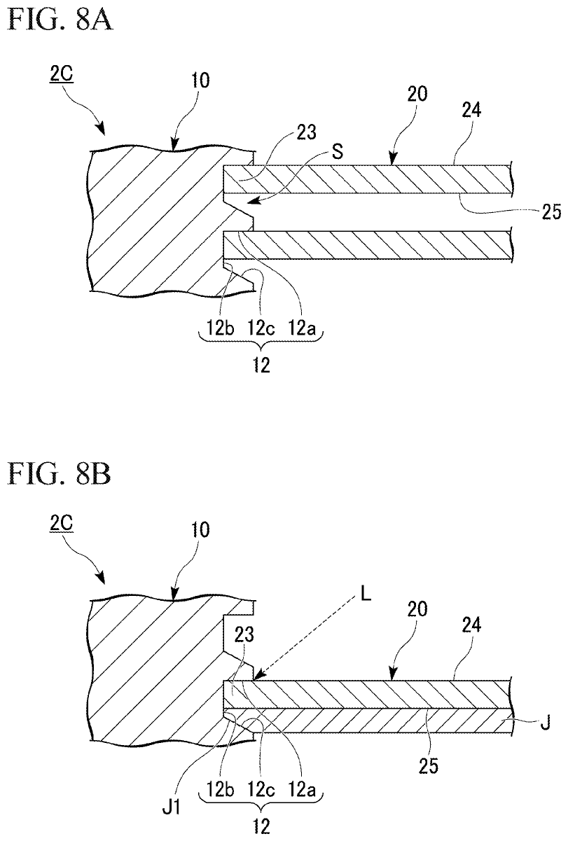

As shown in FIG. 8A, in the comb 2C according to one or more embodiments, the lower inner surface 12c of the groove 12 is an inclined surface. The arm 20 is joined to the upper inner surface 12a of the groove 12 in a state where the base end portion 23 abuts against the bottom surface 12b of the groove 12. An inclined surface 12c is disposed so as to face the lower surface 25 or the upper surface 24 of the arm 20 with the gap S interposed therebetween.

FIG. 8B is a view showing a step in manufacturing the comb 2C in FIG. 8A. As shown in FIG. 8B, when the joining jig J is inserted into the groove 12 together with the arm 20, the inclined surface 12c serves as a guide, and the manufacturing step can be further facilitated. The joining jig J is formed with an inclined surface J1 that comes into surface contact with the inclined surface 12c when the joining jig J is inserted into the groove 12. The other points are the same as those of the above-described embodiments, and a description thereof is omitted here.

The upper inner surface 12a of the groove 12 may be an inclined surface, and the arm 20 may be joined to the lower inner surface 12c of the groove 12.

The technical scope of the present invention is not limited to the above-described embodiments, and various changes can be made without departing from the spirit of the present invention.

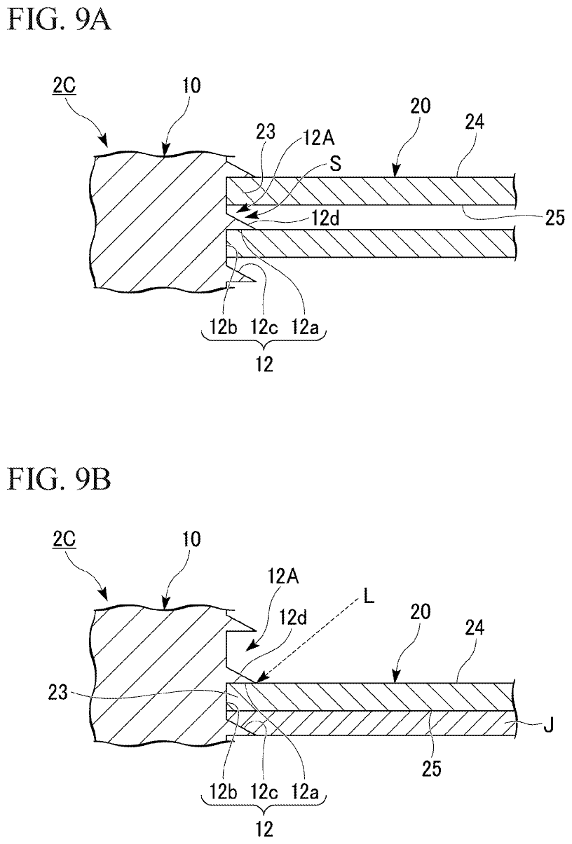

For example, in the comb 2C according to one or more embodiments, as shown in FIG. 9A, the tip end of the inclined surface may have an edge shape. In FIG. 9A, the arm 20 is joined to the upper inner surface 12a of the groove 12, and the lower inner surface 12c of the groove 12 is an inclined surface. In addition, a lower inner surface 12d of another groove 12A adjacent to the upper side of the groove 12 is also an inclined surface. The upper inner surface 12a of the groove 12 and the lower inner surface 12d of the other groove 12A intersect at an acute angle.

FIG. 9B is a view showing a step in manufacturing the comb 2C in FIG. 9A. As shown in FIG. 9B, the laser beam L is irradiated to the tip end portion of the edge formed by the inner surface 12a of the groove 12 and the inner surface 12d of the other groove 12A. In this case, the edge is easily melted by the heat of the laser beam L, the amount of welding is increased, and the joining strength can be further increased.

In addition, it is possible to appropriately replace the components in the above-described embodiments with known components without departing from the spirit of the present invention, and the above-described embodiments and modification may be appropriately combined.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 . . . actuator
2A-2C . . . hard disk comb
3 . . . suspension
4 . . . magnetic head
5 . . . coil holding portion
6 . . . coil
10 . . . main body
12 . . . groove
12c . . . inclined surface
20 . . . arm
21 . . . tip end portion
24 . . . upper surface
25 . . . lower surface
J . . . joining jig
P . . . joining portion
S . . . gap

What is claimed is:

1. A hard disk comb comprising:
a main body comprising a groove; and
an arm joined to the main body, wherein
a part of the arm is disposed inside the groove, and
an opening edge of the groove is joined to an upper surface of the arm.

2. The hard disk comb according to claim 1, wherein
the arm is in a plate shape, and
the upper surface of the arm is joined to the main body but a lower surface of the arm is not joined to the main body.

3. The hard disk comb according to claim 1, wherein the arm is welded to the main body.

4. The hard disk comb according to claim 3, wherein the arm is laser-welded to the main body.

5. The hard disk comb according to claim 1, wherein the main body is joined to the arm at three or more joining portions that are not disposed on a straight line.

6. The hard disk comb according to claim 1, wherein
the arm comprises an aluminum layer and SUS layers disposed on both surfaces of the aluminum layer, and
the main body is formed of SUS.

7. The hard disk comb according to claim 1, wherein a gap is between the arm and an inner surface of the groove.

8. The hard disk comb according to claim 1, wherein a part of an inner surface of the groove is an inclined surface.

9. The hard disk comb according to claim 8, wherein the inclined surface faces the arm with a gap between the arm and the inner surface of the groove.

10. An actuator comprising:
the hard disk comb according to claim 1;
a suspension attached to a tip end portion of the arm;
a magnetic head attached to the suspension;
a coil holding portion fixed to or integrated with the main body; and
a coil held by the coil holding portion.

11. A hard disk comb comprising:
a main body comprising a groove; and
an arm joined to the main body, wherein
a part of the arm is disposed inside the groove,
the arm comprises an aluminum layer and SUS layers on both surfaces of the aluminum layer, and
the main body is made of SUS.

12. A manufacturing method of a hard disk comb comprising:
preparing a main body comprising a groove;
inserting an arm and a joining jig in the groove;
joining the arm to the main body; and
extracting the joining jig from the groove.
